(19) United States
(12) Patent Application Publication
(10) Pub. No.: US 2013/0283074 A1
(43) Pub. Date: Oct. 24, 2013

(54) POWER INFORMATION CENTER OF SERVER SYSTEM

(71) Applicants: Hong Fu Jin Precision Industry (ShenZhen) Co., Ltd., (US); HON HAI PRECISION INDUSTRY CO., LTD., New Taipei (TW)

(72) Inventors: KANG WU, Shenzhen (CN); WEI-DONG CONG, Shenzhen (CN)

(73) Assignees: Hong Fu Jin Precision Industry (Shenzhen) Co., Ltd., Shenzhen (CN); HON HAI PRECISION INDUSTRY CO., LTD., New Taipei (TW)

(21) Appl. No.: 13/710,735

(22) Filed: Dec. 11, 2012

(30) Foreign Application Priority Data
Apr. 19, 2012 (CN) 201210116037.1

(51) Int. Cl. G06F 1/26

(52) U.S. Cl. CPC G06F 1/266
USPC 713/321

(57) ABSTRACT

A server system includes at least one server unit, a power unit, and a control unit. The control unit includes at least one device module, a storage module, and a power module. The power module receives power information of the power unit in real-time, and the storage module stores the power information. All of the at least one server unit can simultaneously read the power information from the storage module through the at least one device module.

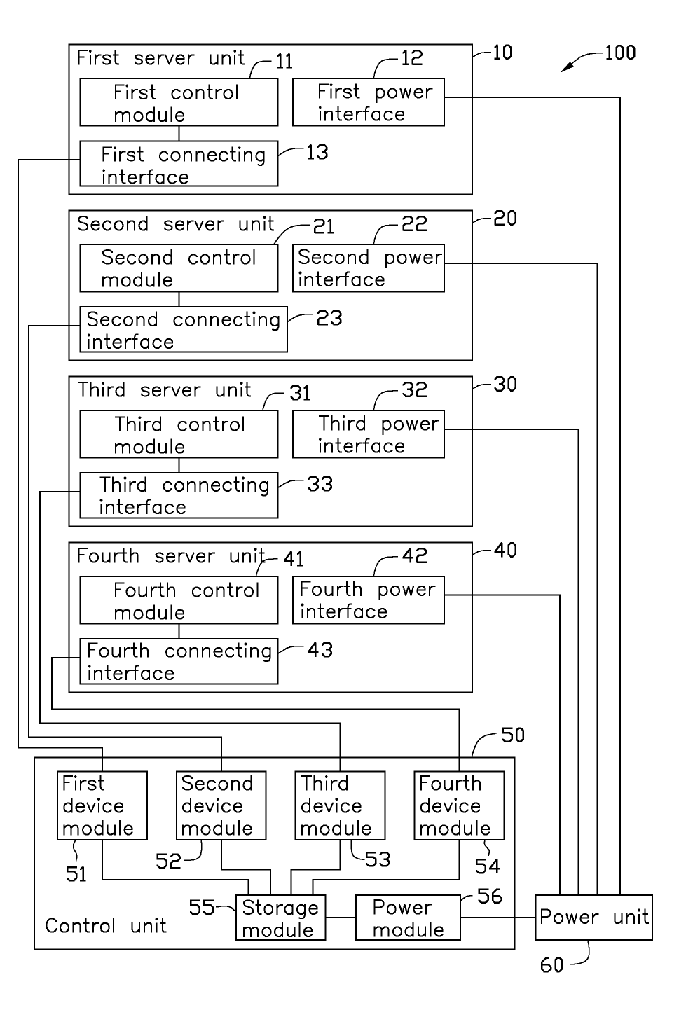

### BACKGROUND

1. Technical Field

The present disclosure relates to a power information center, and particularly to a power information center of a server system.

2. Description of Related Art

In a high density server system, the number of servers is limited by the size of a receiving space, such as a server room. Therefore, a server administrator often uses one power unit to supply power to a plurality of servers at the same time. However, when a plurality of users simultaneously requests power state information, some users will not receive the power state information because the control chips of their servers may not support bus arbitration.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a block diagram of an embodiment of a server system of the present disclosure.

### DETAILED DESCRIPTION

The FIGURE illustrates an embodiment of a server system 100 of the present disclosure. The server system 100 includes a first server unit 10, a second server unit 20, a third server unit 30, a fourth server unit 40, a control unit 50, and a power unit 60. In the embodiment, the control unit 50 is a programmable logic controller used as a power information center, and the power unit 60 is a power supply unit (PSU). In other embodiments, the server system of the present disclosure can include at least one server unit. In other words, a number of the server units in the server system 100 can be predetermined according to demand. In the embodiment, the control unit 50 is a complex programmable logic device (CPLD).

The first server unit 10 includes a first control module 11, a first power interface 12, and a first connecting interface 13. The second server unit 20 includes a second control module 21, a second power interface 22, and a second connecting interface 23. The third server unit 30 includes a third control module 31, a third power interface 32, and a third connecting interface 33. The fourth server unit 40 includes a fourth control module 41, a fourth power interface 42, and a fourth connecting interface 43. The first control module 11 is connected to the first connecting interface 13, the second control module 21 is connected to the second connecting interface 23, the third control module 31 is connected to the third connecting interface 33, and the fourth control module 41 is connected to the fourth connecting interface 43. The power unit 60 is connected to the first to the fourth power interfaces 12-42 to supply power to the first to the fourth server units 10-40. In the embodiment, each of the connecting interfaces 13-43 is a bus interface.

The control unit 50 includes a first device module 51, a second device module 52, a third device module 53, a fourth device module 54, a storage module 55, and a power module 56. The storage module 55 is connected to the power unit 60 through the power module 56. Because a number of the server units in the server system 100 can be predetermined according to demand, a number of the device modules in the control unit 50 needs to be corresponding to the number of the server units.

The power module 56 receives power information generated by the power unit 60 and the storage module 55 receives the power information from the power module 56 and stores the power information. The receiving process and the storing process can be real-time. The first to the fourth device modules 51-54 are connected to the storage module 55 to receive the power information. The first device module 51 is connected to the first connecting interface 13, the second device module 52 is connected to the second connecting interface 23, the third device module 53 is connected to the third connecting interface 33, and the fourth device module 54 is connected to the fourth connecting interface 43. Each of the device modules 51-54 transmits the power information to each of the control modules 11-41 through each of the connecting interfaces 13-43.

When the first to the fourth control modules 11-41 make requests to receive the power information of the power unit 60 at the same time, each of the four control modules 11-41 transmits a command to the control unit 50 through each of the four connecting interfaces 13-43. Each of the four device modules 51-54 receives a corresponding one of the commands to read the power information from the storage module 55 and transmits the power information to a corresponding one of the four control modules 11-41 through a corresponding one of the four connecting interfaces 13-43.

The server system 100 of the present disclosure can read the power information of the power unit 60 through the power module 56 of the control unit 50, and store the power information in the storage module 55 in real-time. Therefore, a plurality of server units can receive the power information from the storage module 55 through a corresponding one of a plurality of device modules and a corresponding one of a plurality of connecting interfaces when some or all of the plurality of server units 10-40 make requests to receive the power information at the same time. Accordingly, even though the control chips of the servers do not support bus arbitration function, power information of the power supply can be read simultaneously.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A server system comprising:
a first server unit comprising a first control module and a first connecting interface connected to the first control module;
a second server unit comprising a second control module and a second connecting interface connected to the second control module; and
a control unit comprising a first device module, a second device module, a storage module, and a power module, wherein the power module is connected to a power unit supplying power to the first and second server units to receive power information, the storage module is connected to the power module to store the power information, the first device module is connected to the storage module to receive the power information and transmits the power information to the first control module through the first connecting interface, and the second device module is connected to the storage module to receive the power information and transmits the power information to the second control module through the second connecting interface.

2. The server system of claim 1, further comprising:
a third server unit comprising a third control module and a third connecting interface connected to the third control module, wherein the control unit further comprises a third device module connected to the storage module, and the third device module receives the power information and transmits the power information to the third control module through the third connecting interface.

3. The server system of claim 2, wherein the first, the second and the third connecting interfaces are bus interfaces.

4. The server system of claim 1, wherein the control unit is a programmable logic controller.

5. The server system of claim 1, wherein each of the first and the second device modules receives the power information and transmits to a corresponding one of the first and the second control modules when the first control unit transmits a first command to the control unit and the second control unit transmits a second command to the control unit at the same time.

6. The server system of claim 5, wherein the first control unit transmits the first command when the first sever unit makes a request to receive the power information, and the second control unit transmits the second command when the second sever unit makes a request to receive the power information.

7. The server system of claim 1, wherein the first server unit comprises a first power interface, the second server unit comprises a second power interface, and the power unit supplies power to the first server unit through the first power interface and to the second server unit through the second power interface.

8. A power information center comprising:
a power module connected to a power unit to receive power information of the power unit;
a storage module connected to the power module to store the power information; and
at least one device module connected to the storage module to receive the power information, wherein each of the at least one device module transmits the power information to a corresponding one of at least one server unit.

9. The power information center of claim 8, wherein the power unit supplies power to the at least one server unit and generates the power information.
